(19) United States
(12) Patent Application Publication
(10) Pub. No.: US 2023/0008581 A1
(43) Pub. Date: Jan. 12, 2023

(54) FRAUD DAMAGE PREVENTION SYSTEM, FRAUD DAMAGE PREVENTION METHOD, CALL PROCESSING SERVER, ENUM / DNS SERVER, AND PROGRAM

(71) Applicant: Nippon Telegraph and Telephone Corporation, Tokyo (JP)

(72) Inventor: Yuta Sugiki, Musashino-shi, Tokyo (JP)

(21) Appl. No.: 17/783,904

(22) PCT Filed: Dec. 16, 2019
(86) PCT No.: PCT/JP2019/049155

§ 371 Date: Jun. 9, 2022

(51) Int. Cl. H04M 3/22; H04M 3/42

(52) U.S. Cl. CPC H04M 3/2281; H04M 3/42059

(57) ABSTRACT

A fraud damage prevention system (1000) includes a call processing server (20) and an ENUM/DNS server (10). The call processing server (20) includes: a fraud determination requesting unit that transmits a fraud number determination request, to which a call originating number of a call originating device (4) is affixed, to the ENUM/DNS server (10), and that receives the determination result as to whether or not the call originating number is a fraud number; and a fraud prevention processing unit that performs a predetermined fraud damage prevention process. The ENUM/DNS server (10) includes: a storage unit that stores fraud number information (100); and a fraud determination unit that references the fraud number information (100) using the call originating number, determines that the call originating number is a fraud number in the case where a number that is the same as the call originating number is registered, and transmits the determination result to the call processing server (20).

### TECHNICAL FIELD

The present invention relates to a fraud damage prevention system, a fraud damage prevention method, a call processing server, an ENUM/DNS server, and a program for preventing damage from fraud in which telephone is used.

### BACKGROUND ART

In recent years, damage from bank transfer scams (special scams) has been increasing, and “it's me scams” in which telephone is used, in particular, occupy almost half of the special scams. The “it's me scams” are fraud in which a fraud makes a call, pretending to be a family member (such as a child or a grandchild) of a person who receives the call, in an attempt to cheat the person out of money for a reason that he/she “needs money urgently”. The amount of damage from the it's me scams is increasing year by year, and the number of it's me scam cases that occurred in 2018 exceeded 9,000.

In view of the occurrence of a large number of fraud cases in which telephone is used such as it's me scams, there are disclosed a technique of informing a caller that the conversation is being recorded and a technique of making an announcement to call attention to fraud on the call receiving side before answering a call (see NPL 1).

### CITATION LIST

### Non Patent Literature

[NPL 1] “Telephone—List of Functions—Security”, Panasonic, [search made on Dec. 2, 2019], Internet <URL: https://panasonic.jp/phone/products/kihonkinou.html>

### SUMMARY OF THE INVENTION

### Technical Problem

In a conventional technique of preventing fraud in which telephone is used, as illustrated in FIG. 11, a block number list 101 is registered in advance in a call receiving device 50 located on the call receiving side. Then, the call receiving device 50 matches call information (call originating number) on a received signal using the block number list 101, and regulates a call that matches or calls attention using a guidance device 30a.

Examples of the call receiving device 50 include an IP (Internet Protocol) telephone (receiving terminal 5) provided in homes and a PBX (Private Branch Exchange) 55 installed in offices, factories, buildings, hotels, etc.

However, the conventional technique of preventing fraud in which telephone is used involves the following issues in “regulating” the relevant call and “using the guidance device”.

In regulating a call from a number in the block number list, the network (NW) resource is consumed wastefully, since the call receiving device imposes regulation and the relevant call (malicious call) is distributed on the NW.

In using the guidance device, meanwhile, it is necessary to provide the call receiving device with the guidance device (guidance function).

That is, in the conventional technique, it is necessary to implement the technique of preventing fraud on the call receiving side.

The present invention has been made in view of such issues, it is therefore an object of the present invention to execute a fraud damage prevention process on the network side which is closer to the call originating device (originating terminal), rather than on the call receiving side, in preventing fraud in which telephone is used.

### Means for Solving the Problem

The present invention provides a fraud damage prevention system including a call processing server that makes a call connection between a call originating device and a call receiving device and an ENUM/DNS server that is connected to the call processing server and that performs a process of resolving connection destination information on the call receiving device, in which: the call processing server includes a fraud determination requesting unit that transmits a fraud number determination request, to which a call originating number of the call originating device is affixed, to the ENUM/DNS server when a connection request is received from the call originating device, and that receives a determination result as to whether or not the call originating number is a fraud number which indicates a number to be subjected to anti-fraud measures, and a fraud prevention processing unit that performs a predetermined fraud damage prevention process in a case where the determination result indicates that the call originating number is the fraud number; and the ENUM/DNS server includes a storage unit that stores fraud number information in which the fraud number is registered, and a fraud determination unit that references the fraud number information using the call originating number which is affixed to the received fraud number determination request, determines that the call originating number is the fraud number in a case where a number that is the same as the call originating number is registered, and transmits a determination result to the call processing server.

### Effects of the Invention

With the present invention, it is possible to execute a fraud damage prevention process on the network side which is closer to the call originating device (originating terminal), rather than on the call receiving side, in preventing fraud in which telephone is used.

### BRIEF DESCRIPTION OF DRAWINGS

FIG. 1 illustrates an overall configuration of a fraud damage prevention system according to the present embodiment.

FIG. 2 illustrates an overall configuration of a fraud damage prevention system according to a first embodiment of the present invention.

FIG. 3 is a functional block diagram illustrating an example of the configuration of an ENUM/DNS server according to the present embodiment.

FIG. 4 is a functional block diagram illustrating an example of the configuration of a call processing server according to the first embodiment of the present invention.

FIG. 5 is a sequence diagram illustrating the flow of a process performed by the fraud damage prevention system according to the first embodiment of the present invention.

FIG. 6 illustrates an overall configuration of a fraud damage prevention system according to a second embodiment of the present invention.

FIG. 7 is a functional block diagram illustrating an example of the configuration of a call processing server according to the second embodiment of the present invention.

FIG. 8 is a sequence diagram illustrating the flow of a process performed by the fraud damage prevention system according to the second embodiment of the present invention.

FIG. 9 illustrates an overall configuration of a fraud damage prevention system according to a modification of the second embodiment of the present invention.

FIG. 10 is a hardware configuration diagram illustrating an example of a computer that implements the functions of the ENUM/DNS server and the call processing server according to the present embodiment.

FIG. 11 illustrates a system that prevents fraud on the call receiving side according to the related art.

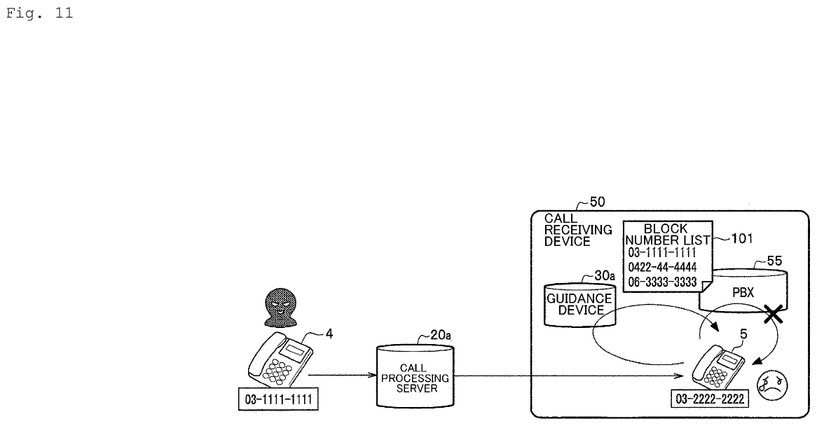

FIG. 12 illustrates a call connection made using an ENUM/DNS server.

### DESCRIPTION OF EMBODIMENTS

Now, an embodiment (hereinafter referred to as a “present embodiment”) for carrying out the present invention will be described. First, an overview of the present invention will be described.

<Overview>

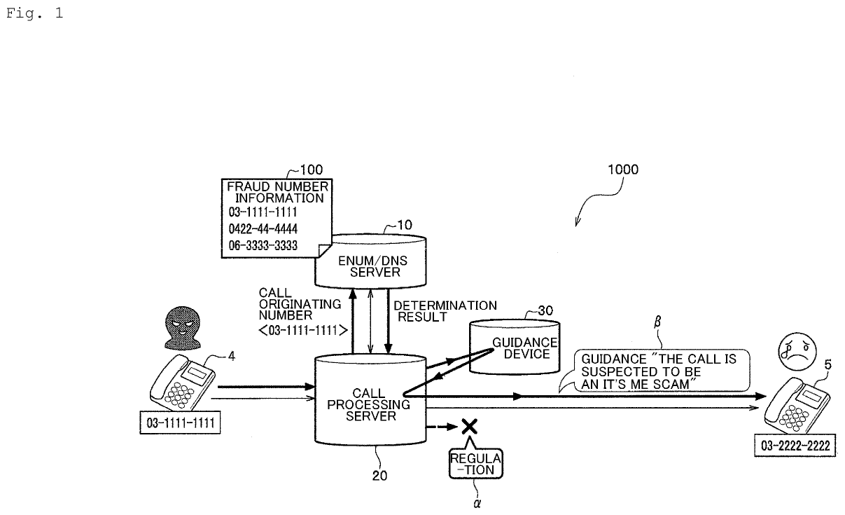

A fraud damage prevention system (see FIG. 1 to be described later) according to the present embodiment is characterized in including a function for preventing damage from fraud in which telephone is used (such as a function of regulating a call and a function of providing guidance through a guidance device) on the network side, rather than on the call receiving side.

More specifically, an ENUM (E. 164 Number Mapping)/DNS (Domain Name System) server includes information (hereinafter referred to as “fraud number information” (blacklist)) on a call originating number to be subjected to anti-fraud measures. Upon receiving an inquiry from a call processing server, the ENUM/DNS server determines, on the basis of the call originating number, whether or not the number is registered in the fraud number information, and returns the determination result to the call processing server. The call processing server regulates a call, or distributes guidance through a guidance device, as a fraud damage prevention process set in advance (predetermined fraud damage prevention process).

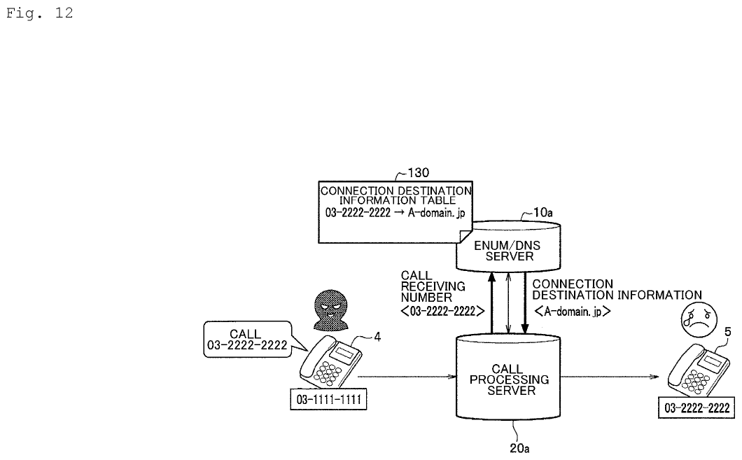

Conventionally, as illustrated in FIG. 12, a call processing server 20a and an ENUM/DNS server 10a perform a process of resolving connection destination information, and makes a call connection between an originating terminal 4 and a receiving terminal 5.

Specifically, upon receiving a connection request (call origination) from the originating terminal 4, the call processing server 20a inquires of the ENUM/DNS server 10a information (routing information) on the connection destination of the receiving terminal 5 using the telephone number (call receiving number) of the receiving terminal 5. Then, upon receiving the inquiry, the ENUM/DNS server 10a references a connection destination information table 130, and returns an IP address, a domain name, etc. as the connection destination information (routing information) for the call receiving number. The call processing server 20a makes a call connection with the receiving terminal 5 on the basis of the returned connection destination information.

The ENUM/DNS server is described in detail in NPL (“TTC Standard JJ-90.31: Common Interconnection Interface for Carrier ENUM”, version 4.0, Aug. 29, 2018, the Telecommunication Technology Committee).

A fraud damage prevention system according to the present invention which uses the ENUM/DNS server will be described.

FIG. 1 illustrates an overall configuration of a fraud damage prevention system 1000 according to the present embodiment.

As illustrated in FIG. 1, the fraud damage prevention system 1000 according to the present embodiment is configured to include a call processing server 20 that houses a call originating device (originating terminal) 4 and an ENUM/DNS server 10 connected to the call processing server 20.

In the fraud damage prevention system 1000 according to the present embodiment, the ENUM/DNS server 10 includes fraud number information 100, and the call processing server 20 transmits a call originating number for a call, for which a connection request has been received, to the ENUM/DNS server 10 using an interface between the ENUM/DNS server 10 and the call processing server 20, the interface being provided to the call processing server 20 as a conventional feature. Then, the ENUM/DNS server 10 determines whether or not the call originating number is registered in the fraud number information 100, that is, whether or not the call originating number is a number to be subjected to anti-fraud measures, and transmits the determination result to the call processing server 20. In the case where the call originating number is determined as a number to be subjected to anti-fraud measures, the call processing server 20 regulates the call, or distributes guidance, as a fraud damage prevention function set in advance.

In this manner, the fraud damage prevention system 1000 according to the present embodiment can regulate the call (symbol a in FIG. 1), or distribute guidance using a guidance device 30 (symbol β in FIG. 1), on the network side which is closer to the call originating device (originating terminal) 4, rather than on the call receiving side.

The fraud damage prevention system 1000 according to the present invention will be described below with the case where a call is to be regulated defined as a first embodiment and with the case where the guidance device 30 is used defined as a second embodiment.

### First Embodiment

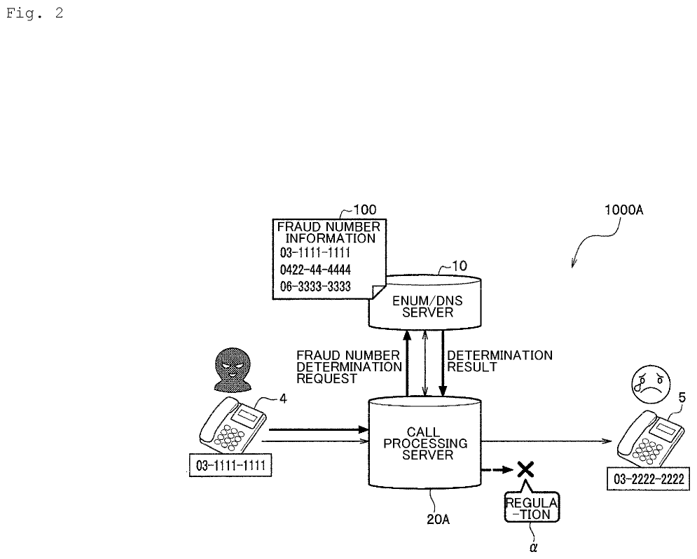

First, a fraud damage prevention system 1000A according to a first embodiment of the present invention will be described with reference to FIGS. 2 to 5.

FIG. 2 illustrates an overall configuration of the fraud damage prevention system 1000A according to the first embodiment of the present invention.

In the fraud damage prevention system 1000A according to the first embodiment, as illustrated in FIG. 2, a call processing server 20A inquires whether or not a call originating number for a connection request (call) received from the call originating device (originating terminal) 4 is a number (hereinafter occasionally referred to as a “fraud number”) to be subjected to anti-fraud measures, by transmitting the call originating number to the ENUM/DNS server 10 as included in a fraud number determination request. The ENUM/DNS server 10 references the fraud number information 100 (blacklist) which is registered in advance, determines that the call originating number is a fraud number if the call originating number is registered, and returns the determination result to the call processing server 20A. In the case where a determination result indicating that the call originating number is a fraud number is received, the call processing server 20A according to the first embodiment regulates the call (connection request) (symbol a in FIG. 2) . Specifically, the relevant call is canceled (disconnected).

The ENUM/DNS server 10 and the call processing server 20A which constitute the fraud damage prevention system 1000A will be specifically described below.

«ENUM/DNS Server 10»

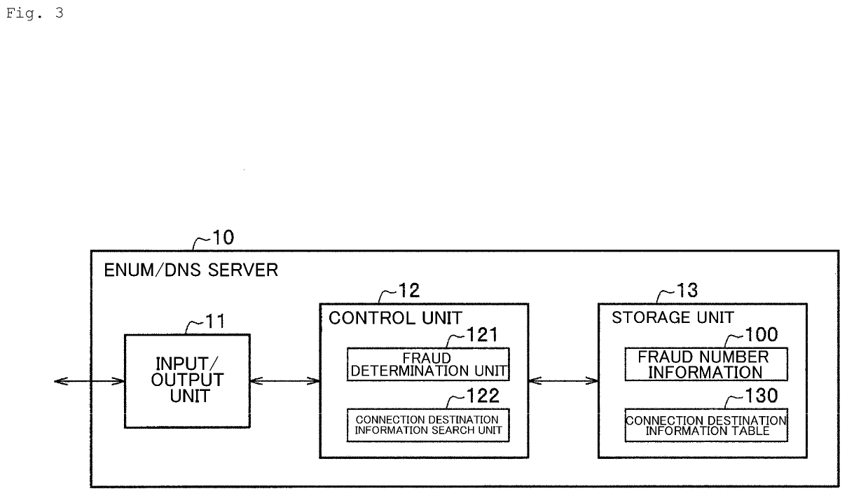

FIG. 3 is a functional block diagram illustrating an example of the configuration of the ENUM/DNS server 10 according to the present embodiment.

The ENUM/DNS server 10 includes a function of returning connection destination information (routing information) on a call receiving number in response to an inquiry from the call processing server 20A, which is a conventional function. Further, the ENUM/DNS server 10 determines whether or not the call originating number is registered in the fraud number information 100 (blacklist), which is a list of numbers to be subjected to anti-fraud measures, and transmits the determination result to the call processing server 20A.

The ENUM/DNS server 10 includes an input/output unit 11, a control unit 12, and a storage unit 13.

The input/output unit 11 receives input of information from and outputs information to other devices etc. For example, the input/output unit 11 transmits and receives information to and from the call processing server 20. The input/output unit 11 is composed of a communication interface through which information is transmitted and received via a communication line, and an input/output interface through which information is input to and output from an input device such as a keyboard and an output device such as a monitor (not illustrated).

The storage unit 13 is composed of a hard disk, a flash memory, a RAM (Random Access Memory), etc.

The storage unit 13 stores the fraud number information 100 and the connection destination information table 130.

The fraud number information 100 is information in which numbers (fraud numbers) to be subjected to anti-fraud measures are registered as a so-called blacklist. The fraud number information 100 is stored in the ENUM/DNS server 10 as information prepared in advance.

The connection destination information table 130 stores connection destination information (routing information) in correlation with each call receiving number (telephone number of the receiving terminal 5).

Further, the storage unit 13 temporarily stores a program for implementing functional units of the control unit 12 and information that is necessary for processing performed by the control unit 12.

The control unit 12 governs all the processes executed by the ENUM/DNS server 10, and is configured to include a fraud determination unit 121 and a connection destination information search unit 122.

The fraud determination unit 121 receives a fraud number determination request, to which a call originating number of the call originating device (originating terminal) 4 is affixed, from the call processing server 20. Then, the fraud determination unit 121 determines whether or not the call originating number affixed to the fraud number determination request is registered in the fraud number information 100. If the call originating number is registered in the fraud number information 100, the fraud determination unit 121 determines that the call originating number is a number (fraud number) to be subjected to anti-fraud measures. If the call originating number is not registered in the fraud number information 100, meanwhile, the fraud determination unit 121 determines that the call originating number is not a number (fraud number) to be subjected to anti-fraud measures. Then, the fraud determination unit 121 returns the determination result to the call processing server 20.

When an inquiry about connection destination information (routing information) on the call receiving number (telephone number of the receiving terminal 5) is received from the call processing server 20, the connection destination information search unit 122 references the connection destination information table 130, extracts connection destination information (routing information) corresponding to the call receiving number, and returns the extracted connection destination information to the call processing server 20.

In this manner, the ENUM/DNS server 10 can determine whether or not the call originating number of the call originating device (originating terminal) 4 is a number (fraud number) that needs anti-fraud measures using a conventional interface between the call processing server 20 and the ENUM/DNS server 10.

«Call Processing Server 20A»

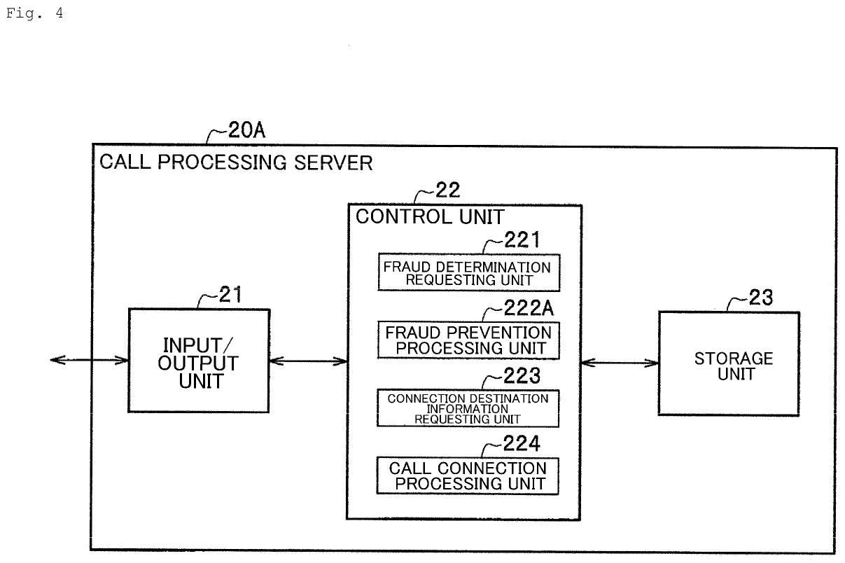

FIG. 4 is a functional block diagram illustrating an example of the configuration of the call processing server 20A according to the first embodiment of the present invention.

The call processing server 20A receives a connection request (call) from each call originating device (originating terminal) 4 housed in the call processing server 20A itself. Then, the call processing server 20A transmits a fraud number determination request, to which the call originating number of the call originating device 4 is affixed, to the ENUM/DNS server 10, and receives the determination result as to whether or not the call originating number is a number (fraud number) to be subjected to anti-fraud measures. In the case where the determination result indicates that the call originating number is a fraud number, the call processing server 20A executes a regulation process on the connection request (call).

The call processing server 20A includes an input/output unit 21, a control unit 22, and a storage unit 23.

The input/output unit 21 receives input of information from and outputs information to other devices etc. For example, the input/output unit 21 transmits and receives information to and from each terminal (such as the call originating device (originating terminal) 4 and the receiving terminal 5) , the ENUM/DNS server 10, etc. The input/output unit 21 is composed of a communication interface through which information is transmitted and received via a communication line, and an input/output interface through which information is input to and output from an input device such as a keyboard and an output device such as a monitor (not illustrated).

The storage unit 23 is composed of a hard disk, a flash memory, a RAM, etc.

The storage unit 23 temporarily stores a program for implementing functions of the control unit 22 and information that is necessary for processing performed by the control unit 22.

The control unit 22 governs all the processes executed by the call processing server 20A, and is configured to include a fraud determination requesting unit 221, a fraud prevention processing unit 222A, a connection destination information requesting unit 223, and a call connection processing unit 224.

The fraud determination requesting unit 221 receives a connection request (call) from a call originating device (originating terminal) 4 housed in the call processing server 20A itself. Then, the fraud determination requesting unit 221 generates a fraud number determination request, to which the call originating number of the call originating device (originating terminal) 4 is affixed, and transmits the generated fraud number determination request to the ENUM/DNS server 10.

Then, the fraud determination requesting unit 221 receives, from the ENUM/DNS server 10, the determination result as to whether or not the call originating number of the call originating device (originating terminal) 4 is a number (fraud number) to be subjected to anti-fraud measures. In the case where the determination result indicates that the call originating number is determined to be a fraud number, the fraud determination requesting unit 221 outputs such an indication to the fraud prevention processing unit 222A. In the case where the determination result indicates that the call originating number is determined not to be a fraud number, on the other hand, the fraud determination requesting unit 221 outputs such an indication to the connection destination information requesting unit 223.

When information indicating that the call originating number of the call originating device (originating terminal) 4 is a fraud number is received from the fraud determination requesting unit 221, the fraud prevention processing unit 222A executes a regulation process on the connection request (call) as a predetermined fraud damage prevention process. Specifically, the fraud prevention processing unit 222A cancels (disconnects) the relevant call.

In the case where the determination result received by the fraud determination requesting unit 221 indicates that the call originating number is not a fraud number, the connection destination information requesting unit 223 generates a message to inquire connection destination information to which a call receiving number is affixed, and transmits the generated message to the ENUM/DNS server 10.

When the connection destination information (routing information) corresponding to the call receiving number is received from the ENUM/DNS server 10, the call connection processing unit 224 makes a call connection to a connection destination indicated in the call receiving information.

«Process by Fraud Damage Prevention System According to First Embodiment»

Next, a process executed by the fraud damage prevention system 1000A will be described.

It is assumed that the ENUM/DNS server 10 stores numbers (fraud numbers) to be subjected to anti-fraud measures in advance as the fraud number information 100. It is also assumed that the call originating device (originating terminal) 4 has made a connection request to the receiving terminal 5 as a call receiving device 50.

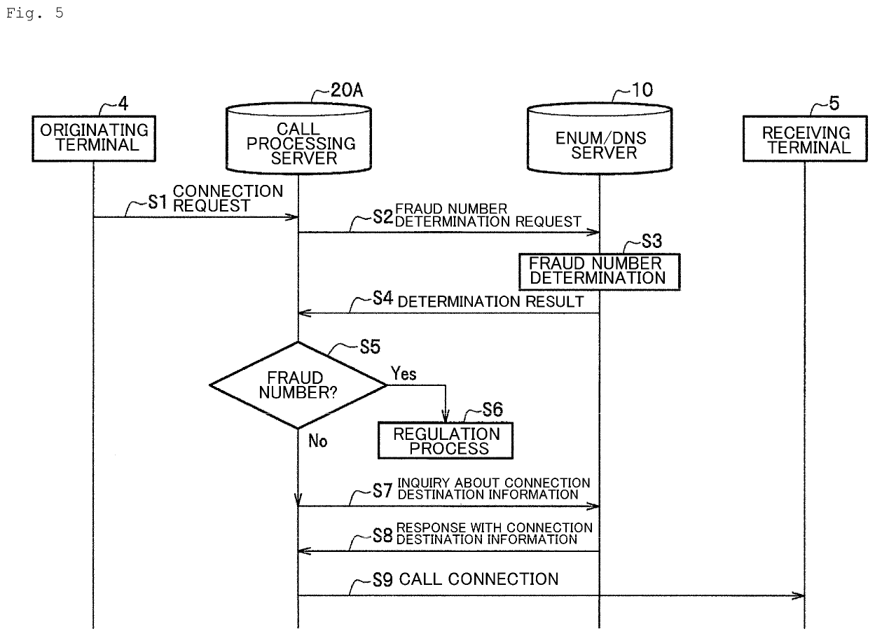

FIG. 5 is a sequence diagram illustrating the flow of a process performed by the fraud damage prevention system 1000A according to the first embodiment of the present invention.

First, the call processing server 20A receives a connection request (call) made from the originating terminal 4 to the receiving terminal 5 (step S1). The call originating number of the originating terminal 4 is affixed to the connection request (call) together with the call receiving number of the receiving terminal 5.

Next, the fraud determination requesting unit 221 of the call processing server 20A generates a fraud number determination request, to which the call originating number of the call originating device (originating terminal) 4 is affixed, and transmits the generated fraud number determination request to the ENUM/DNS server 10 (step S2).

The ENUM/DNS server 10 (fraud determination unit 121) which has received the fraud number determination request determines whether or not the call originating number affixed to the received fraud number determination request is registered in the fraud number information 100 (step S3: fraud number determination).

If the call originating number is registered in the fraud number information 100, the fraud determination unit 121 determines that the call originating number is a number (fraud number) to be subjected to anti-fraud measures. If the call originating number is not registered in the fraud number information 100, meanwhile, the fraud determination unit 121 determines that the call originating number is not a number (fraud number) to be subjected to anti-fraud measures.

Then, the fraud determination unit 121 of the ENUM/DNS server 10 transmits the determination result to the call processing server 20A (step S4).

Subsequently, when the determination result is received from the ENUM/DNS server 10, the fraud determination requesting unit 221 of the call processing server 20A confirms whether or not the determination result indicates that the call originating number is determined as a fraud number (step S5). In the case where the determination result indicates that the call originating number is a fraud number (step S5: Yes), the fraud determination requesting unit 221 outputs such an indication to the fraud prevention processing unit 222A. The fraud prevention processing unit 222A executes a regulation process on the connection request (call) as a fraud damage prevention process (step S6). Specifically, the fraud prevention processing unit 222A cancels (disconnects) the relevant call.

In the case where the determination result indicates that the call originating number is not a fraud number (step S5: No), on the other hand, the fraud determination requesting unit 221 outputs such an indication to the connection destination information requesting unit 223. Then, the connection destination information requesting unit 223 generates a message to inquire connection destination information, to which the call receiving number is affixed, and transmits the generated message to the ENUM/DNS server 10 (step S7: inquiry about connection destination information).

When the inquiry about connection destination information is received, the connection destination information search unit 122 of the ENUM/DNS server 10 references the connection destination information table 130, extracts connection destination information (routing information) corresponding to the call receiving number, and returns the extracted connection destination information to the call processing server 20 (step S8: response with connection destination information).

Next, when the connection destination information (routing information) corresponding to the call receiving number is received from the ENUM/DNS server 10, the call processing server 20A (call connection processing unit 224) makes a call connection to a connection destination indicated in the call receiving information (step S9), and makes a communication connection with the receiving terminal 5.

In this manner, with the fraud damage prevention system 1000A according to the first embodiment of the present invention, the call can be regulated (canceled) on the network side, rather than on the call receiving side in the case where the call originating number of the call originating device (originating terminal) 4 is a number (fraud number) to be subjected to anti-fraud measures. Hence, the fraud damage prevention system 1000A according to the first embodiment of the present invention can prevent fraud damage, and reduce wasteful consumption of the NW resource due to distribution of malicious calls.

### Second Embodiment

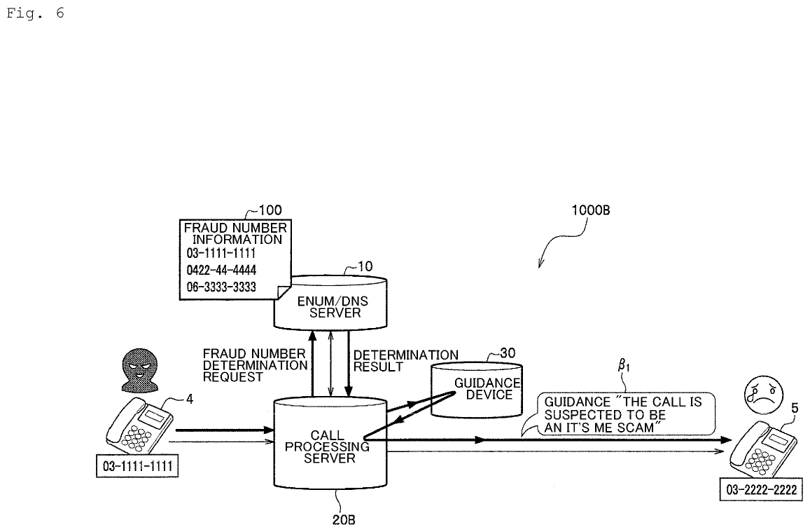

Next, a fraud damage prevention system 1000B according to a second embodiment of the present invention will be described with reference to FIGS. 6 to 8.

FIG. 6 illustrates an overall configuration of the fraud damage prevention system 1000B according to the second embodiment of the present invention.

As illustrated in FIG. 6, the fraud damage prevention system 1000B according to the second embodiment includes a guidance device 30 provided on the network side, in addition to the ENUM/DNS server 10 and a call processing server 20B.

As with the call processing server 20A according to the first embodiment, the call processing server 20B inquires whether or not a call originating number for a call received from the call originating device (originating terminal) 4 is a number (fraud number) to be subjected to anti-fraud measures, by transmitting the call originating number to the ENUM/DNS server 10 as included in a fraud number determination request. The ENUM/DNS server 10 references the fraud number information 100 (blacklist) which is registered in advance, determines that the call originating number is a fraud number if the call originating number is registered, and returns the determination result to the call processing server 20B. In the case where a determination result indicating that the call originating number is a fraud number is received, the call processing server 20B according to the second embodiment distributes guidance through the guidance device 30. For example, the call processing server 20B distributes guidance such as “The call is suspected to be an it's-me-scam call.” to the receiving terminal 5 (see symbol β₁ in FIG. 6).

The ENUM/DNS server 10 which constitutes the fraud damage prevention system 1000B has the same configuration as that of the ENUM/DNS server 10 (see FIGS. 2 and 3) described in relation to the first embodiment, and thus is not described.

«Call Processing Server 20B»

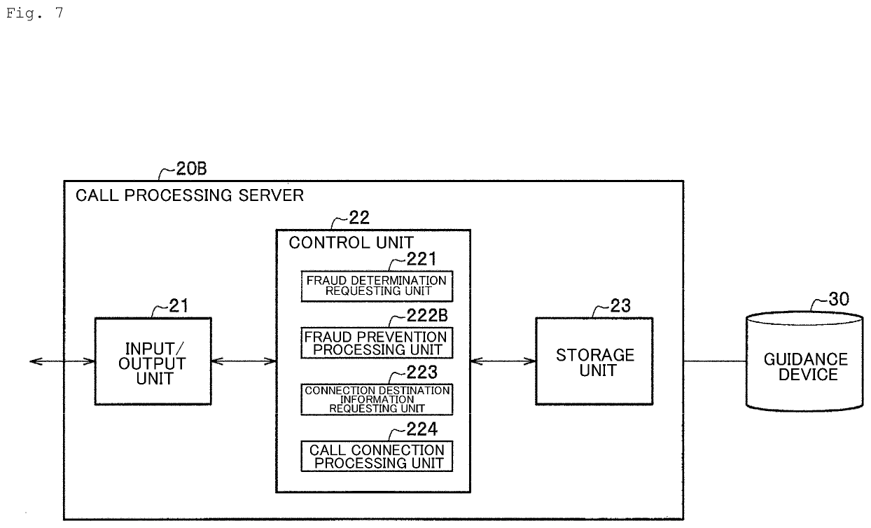

FIG. 7 is a functional block diagram illustrating an example of the configuration of the call processing server 20B according to the second embodiment of the present invention.

The call processing server 20B according to the second embodiment is different from the call processing server 20A according to the first embodiment illustrated in FIG. 4 in that the fraud prevention processing unit 222A has been replaced with a fraud prevention processing unit 222B. The other components are the same as those of the call processing server 20A, and thus are given the same reference numerals and names to omit detailed description.

The call processing server 20B receives a connection request (call) from each call originating device (originating terminal) 4 housed in the call processing server 20B itself. Then, the call processing server 20B transmits a fraud number determination request, to which the call originating number of the call originating device 4 is affixed, to the ENUM/DNS server 10, and receives the determination result as to whether or not the call originating number is a number (fraud number) to be subjected to anti-fraud measures. In the case where the determination result indicates that the call originating number is a fraud number, the call processing server 20B distributes guidance from the guidance device 30 to the receiving terminal 5 to call attention so that the callee will not incur fraud damage.

Voice information to be distributed to the terminal side is registered in advance in the guidance device 30. The guidance device 30 distributes the registered voice guidance to the terminal under control by the call processing server 20B (fraud prevention processing unit 222B and call connection processing unit 224). In the second embodiment, the call processing server 20B and the guidance device 30 are described as separate devices. However, the call processing server 20B may be provided with the function (guidance function) of the guidance device 30.

When information indicating that the call originating number of the call originating device (originating terminal) 4 is a number (fraud number) to be subjected to anti-fraud measures is received from the fraud determination requesting unit 221, the fraud prevention processing unit 222B performs control so as to distribute guidance to call attention to fraud damage from the guidance device 30 to the receiving terminal 5 as a predetermined fraud damage prevention process.

«Process by Fraud Damage Prevention System According to Second Embodiment»

Next, a process executed by the fraud damage prevention system 1000B will be described.

It is assumed that the ENUM/DNS server 10 stores numbers (fraud numbers) to be subjected to anti-fraud measures in advance as the fraud number information 100. It is also assumed that the call originating device (originating terminal) 4 has made a connection request to the receiving terminal 5 as a call receiving device 50.

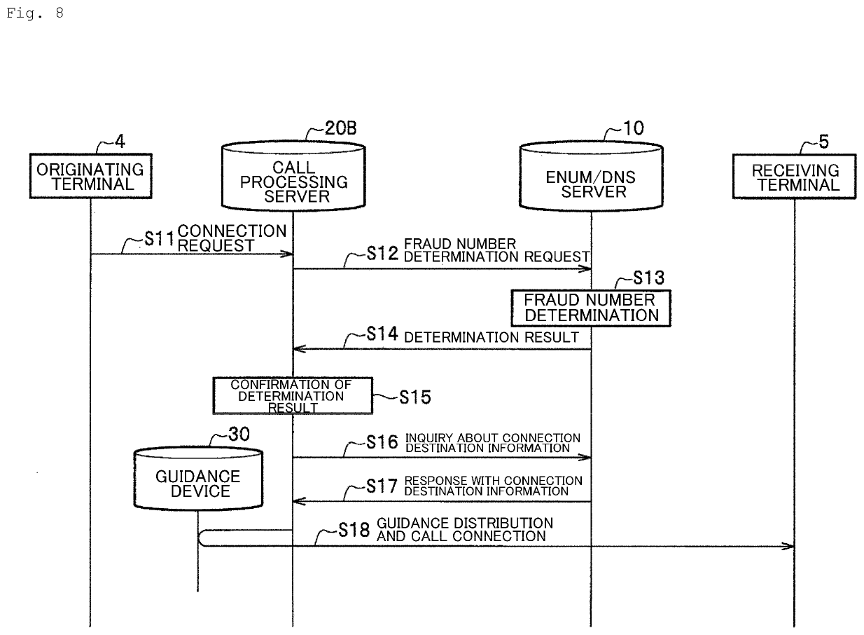

FIG. 8 is a sequence diagram illustrating the flow of a process performed by the fraud damage prevention system 1000B according to the second embodiment of the present invention.

Steps S11 to S14 are the same as the processes (steps S1 to S4) performed by the fraud damage prevention system 1000A according to the first embodiment indicated in FIG. 5, and thus are not described.

When the determination result is received from the ENUM/DNS server 10, the fraud determination requesting unit 221 of the call processing server 20B confirms whether or not the determination result indicates that the call originating number is determined as a fraud number (step S15). In the case where the determination result indicates that the call originating number is a fraud number, the fraud determination requesting unit 221 outputs such an indication to the fraud prevention processing unit 222B.

Subsequently, the connection destination information requesting unit 223 generates a message to inquire connection destination information, to which the call receiving number is affixed, and transmits the generated message to the ENUM/DNS server 10 (step S16: inquiry about connection destination information).

When the inquiry about connection destination information is received, the connection destination information search unit 122 of the ENUM/DNS server 10 references the connection destination information table 130, extracts connection destination information (routing information) corresponding to the call receiving number, and returns the extracted connection destination information to the call processing server 20 (step S17: response with connection destination information).

When the connection destination information (routing information) corresponding to the call receiving number is received from the ENUM/DNS server 10, the call processing server 20B (call connection processing unit 224) makes a connection to a connection destination indicated in the call receiving information. Then, in the case where it is confirmed in step S15 that the determination result indicates a fraud number, the fraud prevention processing unit 222B performs control so as to distribute guidance to call attention to fraud damage from the guidance device 30, and make a call connection through the call connection processing unit 224 (step S18). Here, voice guidance such as “The call is suspected to be an it's-me-scam call”, for example, is distributed from the guidance device 30 to the receiving terminal 5.

In the case where it is confirmed in step S15 that the determination result does not indicate a fraud number, meanwhile, the call processing server 20B does not distribute guidance as normal, and the call connection processing unit 224 makes a call connection.

In this manner, with the fraud damage prevention system 1000B according to the second embodiment of the present invention, the guidance device 30 which is provided on the network side can distribute guidance to call attention to fraud damage. Hence, with the fraud damage prevention system 1000B according to the second embodiment of the present invention, it is possible to eliminate the need to provide the guidance device 30 (guidance function) on the call receiving side in addition to preventing fraud damage.

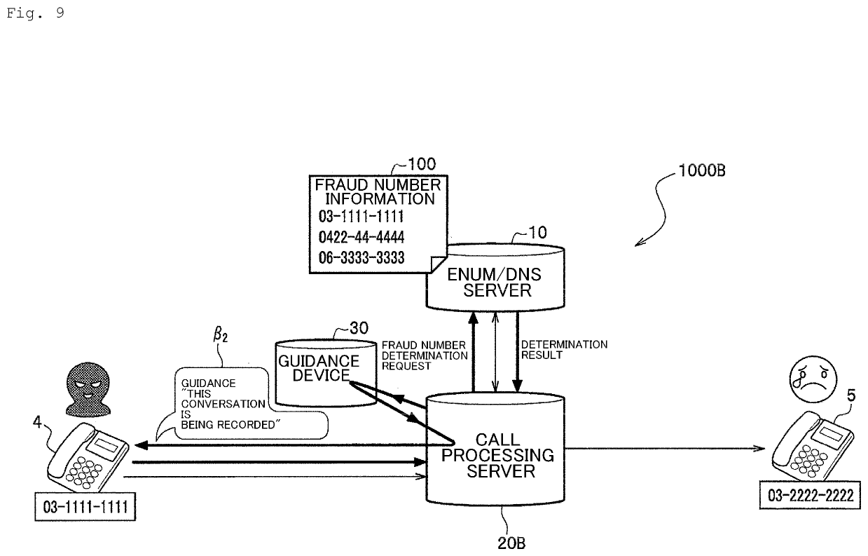

With the fraud damage prevention system 1000B according to the second embodiment described above, guidance to call attention to fraud damage is distributed to the receiving terminal 5. However, the fraud prevention processing unit 222B of the call processing server 20B may distribute voice guidance to the originating terminal 4 as illustrated in FIG. 9. In this case, voice guidance that deters a fraudulent action such as “This conversation is being recorded”, for example, is registered in advance in the guidance device 30. Then, in the case where the fraud determination requesting unit 221 of the call processing server 20B has received a determination result indicating that the call originating number is a fraud number in step S15 in FIG. 8, the fraud prevention processing unit 222B distributes guidance for deterring a fraudulent action to the originating terminal 4 (see symbol β₂ in FIG. 9) as a predetermined fraud damage prevention process.

Further, the fraud prevention processing unit 222B of the call processing server 20B may distribute guidance from the guidance device 30 to both the originating terminal 4 and the receiving terminal 5.

<Hardware Configuration>

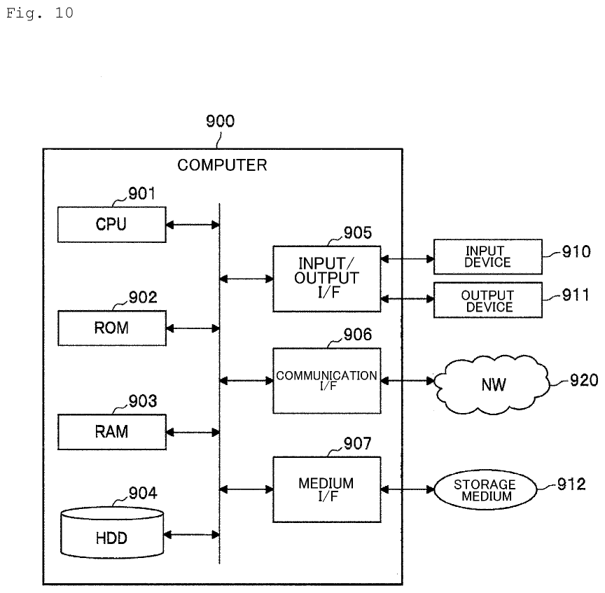

The ENUM/DNS server 10 and the call processing server 20 (20A, 20B) according to the present embodiment are implemented by a computer 900 configured as illustrated in FIG. 10, for example.

FIG. 10 is a hardware configuration diagram illustrating an example of the computer 900 which implements the functions of the ENUM/DNS server 10 and the call processing server 20 (20A, 20B) according to the present embodiment. The computer 900 has a CPU (Central Processing Unit) 901, a ROM (Read Only Memory) 902, a RAM 903, an HDD (Hard Disk Drive) 904, an input/output I/F (Interface) 905, a communication I/F 906, and a medium I/F 907.

The CPU 901 operates on the basis of a program stored in the ROM 902 or the HDD 904, and performs control through the control unit 12, 22 (FIGS. 3 and 7). The ROM 902 stores a boot program to be executed by the CPU 901 to start the computer 900, a program related to the hardware of the computer 900, etc.

The CPU 901 controls an input device 910 such as a mouse and a keyboard and an output device 911 such as a display and a printer via the input/output I/F 905. The CPU 901 acquires data from the input device 910 and outputs generated data to the output device 911 via the input/output I/F 905. A GPU (Graphics Processing Unit) etc. may be used as a processor together with the CPU 901.

The HDD 904 stores a program to be executed by the CPU 901, data to be used by the program, etc. The communication I/F 906 receives data from other devices via a communication network (e.g. NW (Network) 920), outputs the received data to the CPU 901, and transmits data generated by the CPU 901 to other devices via the communication network.

The medium I/F 907 reads a program or data stored in a storage medium 912, and outputs the read program or data to the CPU 901 via the RAM 903. The CPU 901 loads a program related to a target process onto the RAM 903 from the storage medium 912 via the medium I/F 907, and executes the loaded program. The storage medium 912 may be an optical storage medium such as a DVD (Digital Versatile Disc) and a PD (Phase change rewritable Disk), a magneto-optical storage medium such as an MO (Magneto Optical disk), a magnetic storage medium, a semiconductor memory, etc.

In the case where the computer 900 functions as the ENUM/DNS server 10 and the call processing server 20 according to the present invention, for example, the CPU 901 of the computer 900 implements the functions of the ENUM/DNS server 10 and the call processing server 20 by executing the program loaded onto the RAM 903. The HDD 904 also stores data in the RAM 903. The CPU 901 reads a program related to a target process from the storage medium 912, and executes the read program. Besides, the CPU 901 may read a program related to a target process from other devices via the communication network (NW 920).

<Effects>

The effects of the fraud damage prevention system etc. according to the present invention will be described below.

The present invention provides a fraud damage prevention system 1000 including a call processing server 20 that makes a call connection between a call originating device (originating terminal 4) and a call receiving device (receiving terminal 5) and an ENUM/DNS server 10 that is connected to the call processing server 20 and that performs a process of resolving connection destination information on the call receiving device, in which: the call processing server 20 includes a fraud determination requesting unit 221 that transmits a fraud number determination request, to which a call originating number of the call originating device is affixed, to the ENUM/DNS server 10 when a connection request is received from the call originating device, and that receives a determination result as to whether or not the call originating number is a fraud number which indicates a number to be subjected to anti-fraud measures, and a fraud prevention processing unit 222A, 222B that performs a predetermined fraud damage prevention process in a case where the determination result indicates that the call originating number is the fraud number; and the ENUM/DNS server 10 includes a storage unit 13 that stores fraud number information 100 in which the fraud number is registered, and a fraud determination unit 121 that references the fraud number information 100 using the call originating number which is affixed to the received fraud number determination request, determines that the call originating number is the fraud number in a case where a number that is the same as the call originating number is registered, and transmits a determination result to the call processing server 20.

This allows the ENUM/DNS server 10 to store the fraud number information 100 in which a number to be subjected to anti-fraud measures is registered, and to determine whether or not the call originating number is a fraud number. When it is determined that the call originating number is a fraud number, the call processing server 20 executes a predetermined fraud damage prevention process. Hence, it is possible to execute a fraud damage prevention process on the network side which is closer to the call originating device, rather than on the call receiving side.

Consequently, it is possible to prevent the NW resource from being wastefully consumed by malicious calls. Further, it is possible to eliminate the need to provide a special function for preventing fraud damage on the call receiving side.

In the fraud damage prevention system 1000A, in addition, the fraud prevention processing unit 222A executes a regulation process on a call for the connection request as the predetermined fraud damage prevention process.

Consequently, it is possible to prevent the NW resource from being wastefully consumed because of distribution of malicious calls made in an attempt at a bank transfer scam etc.

In the fraud damage prevention system 1000B, in addition, the call processing server 20B includes a guidance device 30, and the fraud prevention processing unit 222B distributes guidance to call attention to fraud damage to the call receiving device (receiving terminal 5) from the guidance device 30 as the predetermined fraud damage prevention process.

This allows guidance to be distributed to the call receiving device from the guidance device 30 which is provided on the network side. Hence, there is no need any more to provide the guidance device 30 (guidance function) on the call receiving side.

In the fraud damage prevention system 1000B, in addition, the call processing server 20B includes a guidance device 30, and the fraud prevention processing unit 222B distributes guidance for suppressing fraud damage to the call originating device (originating terminal 4) from the guidance device 30 as the predetermined fraud damage prevention process.

This allows guidance to be distributed to the call originating device from the guidance device 30 which is provided on the network side. Hence, it is possible to prompt voluntary disconnection of a call on the call originating side, and to decrease distribution of malicious calls over the network.

The present invention provides a call processing server 20 including: a fraud determination requesting unit 221 that receives a connection request from a call originating device (originating terminal 4), transmits a fraud number determination request, to which a call originating number of the call originating device is affixed, to an ENUM/DNS server 10, and receives a determination result as to whether or not the call originating number is a fraud number which indicates a number to be subjected to anti-fraud measures, and a fraud prevention processing unit 222A, 222B that performs a predetermined fraud damage prevention process in a case where the determination result indicates that the call originating number is the fraud number.

This allows the call processing server 20 to inquire of the ENUM/DNS server 10 whether or not the call originating number of the call originating device is a fraud number, and to execute a fraud damage prevention process on the call in the case where the call originating number is a fraud number.

Hence, it is possible to execute a fraud damage prevention process on the network side which is closer to the call originating device, rather than on the call receiving side.

The present invention provides an ENUM/DNS server 10 including: a storage unit 13 that stores fraud number information 100, in which a fraud number which indicates a number to be subjected to anti-fraud measures is registered; and a fraud determination unit 121 that receives a fraud number determination request, to which a call originating number of a call originating device (originating terminal 4) is affixed, references the fraud number information 100 using the call originating number, determines that the call originating number is the fraud number in a case where a number that is the same as the call originating number is registered, and outputs a determination result.

This allows the ENUM/DNS server 10 to store the fraud number information 100 in which a number to be subjected to anti-fraud measures is registered, and to determine whether or not the call originating number is a fraud number. Hence, it is possible to determine, on the network side, whether or not the call originating number is a number (fraud number) that needs fraud damage prevention.

The present invention is not limited to the embodiment described above, and may be modified in many ways within the technical idea of the present invention by a person who has ordinary knowledge in the field.

For example, also in the case where the ENUM/DNS server 10 is composed of an authority server and a cache server, one of the authority server and the cache server may be provided with the fraud number information 100 and the fraud determination unit 121 to be able to respond to a fraud number determination request from the call processing server 20.

In the case where the ENUM/DNS server 10 is provided for each communication carrier, the ENUM/DNS server 10 may not only receive a fraud number determination request from the call processing server 20 of its own network, but also receive a fraud number determination request from a different network and return the determination result to the different network.

### REFERENCE SIGNS LIST

4 Call originating device (originating terminal)
5 Receiving terminal
10 ENUM/DNS server
11, 21 Input/output unit
12, 22 Control unit
13, 23 Storage unit
20, 20A, 20B Call processing server
30 Guidance device
50 Call receiving device
100 Fraud number information
121 Fraud determination unit
122 Connection destination information search unit
130 Connection destination information table
221 Fraud determination requesting unit
222A, 222B Fraud prevention processing unit
223 Connection destination information requesting unit
224 Call connection processing unit
1000, 1000A, 1000B Fraud damage prevention system

1. A fraud damage prevention system comprising: a call processing server configured to make a call connection between a call originating device and a call receiving device; and an ENUM/DNS server that is connected to the call processing server and configured to perform a process of resolving connection destination information on the call receiving device, wherein
the call processing server includes
a fraud determination requesting unit, including one or more processors, configured to transmit a fraud number determination request, to which a call originating number of the call originating device is affixed, to the ENUM/DNS server when a connection request is received from the call originating device, and receive a determination result as to whether or not the call originating number is a fraud number which indicates a number to be subjected to anti-fraud measures, and
a fraud prevention processing unit, including one or more processors, configured to perform a predetermined fraud damage prevention process in a case where the determination result indicates that the call originating number is the fraud number, and
the ENUM/DNS server includes
a storage configured to store fraud number information in which the fraud number is registered, and
a fraud determination unit, including one or more processors, configured to reference the fraud number information using the call originating number which is affixed to the fraud number determination request that has been received, determine that the call originating number is the fraud number in a case where a number that is the same as the call originating number is registered, and transmit a determination result to the call processing server.

2. The fraud damage prevention system according to claim 1, wherein
the fraud prevention processing unit is configured to execute executes a regulation process on a call for the connection request as the predetermined fraud damage prevention process.

3. The fraud damage prevention system according to claim 1, wherein
the call processing server includes a guidance device, and
the fraud prevention processing unit is configured to distribute guidance to call attention to fraud damage to the call receiving device from the guidance device as the predetermined fraud damage prevention process.

4. The fraud damage prevention system according to claim 1, wherein,
the call processing server includes a guidance device, and
the fraud prevention processing unit is configured to distribute guidance for suppressing fraud damage to the call originating device from the guidance device as the predetermined fraud damage prevention process.

5. A fraud damage prevention method employed by a fraud damage prevention system comprising a call processing server that makes a call connection between a call originating device and a call receiving device and an ENUM/DNS server that is connected to the call processing server and that performs a process of resolving connection destination information on the call receiving device, wherein
the call processing server executes
a step of transmitting a fraud number determination request, to which a call originating number of the call originating device is affixed, to the ENUM/DNS server when a connection request is received from the call originating device, and receiving a determination result as to whether or not the call originating number is a fraud number which indicates a number to be subjected to anti-fraud measures, and
performing a predetermined fraud damage prevention process in a case where the determination result indicates that the call originating number is the fraud number; and
the ENUM/DNS server includes a storage medium that stores fraud number information in which the fraud number is registered, and executes
referencing the fraud number information using the call originating number which is affixed to the fraud number determination request that has been received, determining that the call originating number is the fraud number in a case where a number that is the same as the call originating number is registered, and transmitting a determination result to the call processing server.

6. A call processing server comprising:
a fraud determination requesting unit, including one or more processors, configured to receive a connection request from a call originating device, transmit a fraud number determination request, to which a call originating number of the call originating device is affixed, to an ENUM/DNS server, and receive a determination result as to whether or not the call originating number is a fraud number which indicates a number to be subjected to anti-fraud measures, and
a fraud prevention processing unit, including one or more processors, configured to perform a predetermined fraud damage prevention process in a case where the determination result indicates that the call originating number is the fraud number.

7. The call processing server according to claim 6, where in the ENUM/DNS server comprises:
a storage medium configured to store fraud number information, in which a fraud number which indicates a number to be subjected to anti-fraud measures is registered; and
a fraud determination unit, including one or more processors, configured to receive a fraud number determination request, to which a call originating number of a call originating device is affixed, reference the fraud number information using the call originating number, determine that the call originating number is the fraud number in a case where a number that is the same as the call originating number is registered, and output a determination result.

8. (canceled)

9. The fraud damage prevention method according to claim 5, wherein the call processing server executes:
executing a regulation process on a call for the connection request as the predetermined fraud damage prevention process.

10. The fraud damage prevention method according to claim 5, wherein
the call processing server includes a guidance device, and
the call processing server executes:
distributing guidance to call attention to fraud damage to the call receiving device from the guidance device as the predetermined fraud damage prevention process.

11. The fraud damage prevention method according to claim 5, wherein,
the call processing server includes a guidance device, and
the call processing server executes:
distributing guidance for suppressing fraud damage to the call originating device from the guidance device as the predetermined fraud damage prevention process.

12. The call processing server according to claim 6, wherein
the fraud prevention processing unit is configured to execute a regulation process on a call for the connection request as the predetermined fraud damage prevention process.

13. The call processing server according to claim 6, wherein
the call processing server includes a guidance device, and
the fraud prevention processing unit is configured to distribute guidance to call attention to fraud damage to a call receiving device from the guidance device as the predetermined fraud damage prevention process.

14. The call processing server according to claim 6, wherein,
the call processing server includes a guidance device, and
the fraud prevention processing unit is configured to distribute guidance for suppressing fraud damage to the call originating device from the guidance device as the predetermined fraud damage prevention process.
